(19) United States
(12) Patent Application Publication
(10) Pub. No.: US 2010/0151138 A1
(43) Pub. Date: Jun. 17, 2010

(54) ISOCYANATE-EPOXY FORMULATIONS FOR IMPROVED CURE CONTROL

(76) Inventors: Ernesto Occhiello, Thalwil (CH); Fabio Aguirre, Lake Jackson, TX (US)

Correspondence Address: The Dow Chemical Company, P.O. BOX 1967, Midland, MI, 48641, US

(21) Appl. No.: 12/600,552

(22) PCT Filed: May 6, 2008
(86) PCT No.: PCT/US08/62723

§ 371 Date: Nov. 17, 2009

Related U.S. Application Data
(60) Provisional application No. 60/932,122, filed on May 29, 2007.

(51) Int. Cl. B05D 1/36

(52) U.S. Cl. 427/407.1

(57) ABSTRACT

A process for forming a cured composition, including: admixing a blocked isocyanate, an epoxy resin, and a catalyst to form a mixture; reacting the mixture to form at least one of oxazolidone and isocyanurate rings; wherein the reaction product has an oxazolidone-isocyanurate peak in the range of 1710 to 1760 cm⁻¹ as measured by infrared spectroscopy. In some embodiments, the reaction product does not have an isocyanate absorbance peak at about 2270 cm⁻¹ as measured by infrared spectroscopy. In other embodiments, the reaction product does not have a hydroxyl absorbance peak at about 3500 cm⁻¹ as measured by infrared spectroscopy.

### BACKGROUND OF DISCLOSURE

1. Field of the Disclosure

Embodiments disclosed herein relate generally to isocyanate-epoxy formulations. More specifically, embodiments disclosed herein relate to isocyanate-epoxy formulations having improved cure control.

2. Background

Epoxies resins are one of the most widely used engineering resins, and are well-known for their use in composites with high strength fibers. Epoxy resins form a glassy network, exhibit excellent resistance to corrosion and solvents, good adhesion, reasonably high glass transition temperatures, and adequate electrical properties.

Typical performance requirements of thermoset resins, including epoxies, include a high softening point (>200° C.), low flammability, hydrolytic resistance, chemical and solvent resistance, and dielectric rigidity. Epoxy resins may provide these properties, but may include the drawback of slow hardening cycles due to slow kinetics. Hardening cycles may be increased with use of high temperatures; however, higher temperatures may cause overheating of a substrate, or may be difficult to use due to the geometry of the part being cured.

Another drawback to various epoxy systems is the use of solvents and/or the resulting reaction by-products. Solvents and reaction by-products may result in unwanted chemical exposure or release and bubble formation during cure.

For example, PCT Publication No. WO 1992/011304 discloses an adhesive prepared by the reaction of a hindered isocyanate with a diepoxy compound using a zinc based catalyst to result in a linear oxazolidone polymer in the absence of detectable levels of isocyanate trimer. The reaction results in the production of isopropanol, a volatile organic compound that is not expected to react with the diepoxy.

Similarly, Japanese Patent Publication Nos. 2005054027 and 2006213793 disclose production of oxazolidone polymers, each resulting in the production of isopropanol.

Accordingly, there exists a need for thermoset compositions that allow for curing to start at lower temperatures and to boost the temperature by internal heating. Additionally, it may be desirable for these thermoset compositions to not require the use of inert solvents or result in undesirable reaction by-products. Such thermoset compositions may be useful in coating substrates which cannot tolerate high temperatures and parts whose dimensions and shape make it difficult to apply homogeneous heating.

### SUMMARY OF THE DISCLOSURE

In one aspect, embodiments disclosed herein relate to a process for forming a cured composition, including: admixing a blocked isocyanate, an epoxy resin, and a catalyst to form a mixture; reacting the mixture to form at least one of oxazolidone and isocyanurate rings; wherein the reaction product has an oxazolidone-isocyanurate peak in the range of 1710 to 1760 cm⁻¹ as measured by infrared spectroscopy.

In other aspects, embodiments disclosed herein relate to an isocyanate-epoxy composition, including: the reaction product of a blocked isocyanate and an epoxy resin; wherein the reaction product has an oxazolidone-isocyanurate peak in the range of 1710 cm⁻¹ to 1760 cm⁻¹ as measured by infrared spectroscopy.

In other aspects, embodiments disclosed herein relate to a process for forming a coated substrate, including: admixing a blocked isocyanate, an epoxy resin, and a catalyst to form a mixture; coating a substrate with the mixture; reacting the mixture to form at least one of oxazolidone and isocyanurate rings; wherein the reaction product has an oxazolidone-isocyanurate peak in the range of 1710 to 1760 cm⁻¹ as measured by infrared spectroscopy.

In some embodiments, the reaction product of the above described embodiments does not have an isocyanate absorbance peak at about 2270 cm⁻¹ as measured by infrared spectroscopy. In other embodiments, the reaction product does not have a hydroxyl absorbance peak at about 3500 cm⁻¹ as measured by infrared spectroscopy.

Other aspects and advantages will be apparent from the following description and the appended claims.

### BRIEF DESCRIPTION OF DRAWINGS

FIG. 1 is a DSC analysis of a reaction of a curable composition according to embodiments disclosed herein.

### DETAILED DESCRIPTION

In one aspect, embodiments disclosed herein relate to thermoset compositions that may cure or start curing at lower temperatures. In another aspect, embodiments disclosed herein relate to thermoset compositions that may provide internal or self-heating during cure.

In more particular aspects, embodiments disclosed herein relate to thermoset compositions including epoxy resins and blocked or hindered isocyanates. The thermoset composition may be reacted in the presence of a catalyst for the formation of oxazolidones and/or isocyanurate rings, and optionally may be reacted with a hardener or curing agent.

In other aspects, embodiments disclosed herein relate to a process for the formation of a curable composition. The process may include one or more of preparing an isocyanate prepolymer, preparing a blocked isocyanate, and preparing a thermoset resin composition including the blocked isocyanate and an epoxy resin. In other aspects, embodiments disclosed herein relate to using the above described thermoset resin or curable compositions in composites, coatings, adhesives, or sealants that may be disposed on, in, or between various substrates, before, during, or after curing of the composition.

In some aspects, the thermoset composition may be a self-curing composition at low to moderate temperatures. In other aspects, the thermoset composition may be cured using external heating. In other aspects, the stoichiometry of the thermoset compositions may be controlled so as to result in a desired cure profile. In some embodiments, the curable compositions disclosed herein may be formed by admixing a blocked isocyanate, an epoxy resin and a catalyst. In other embodiments, the curable composition may include a hardener.

Properties of the composition resulting after cure may be tailored to a particular application by adjusting the stoichiometry of the curable composition. For example, polyurethane-like compositions may be formed where the curable composition is isocyanate-rich, whereas epoxy-like compositions may be formed where the curable composition is rich in epoxy resin. In yet other embodiments, the curable compositions may include compounds such as polyols and reactive diluents, imparting a degree of flexibility in the cured composition.

In other embodiments, the curable compositions may be cured or reacted to form at least one of an oxazolidone and an isocyanurate ring, wherein the reaction product has an oxazolidone-isocyanurate peak in the range of 1710 to 1760 cm⁻¹ as measured by infrared spectroscopy.

In other embodiments, the reaction product may be substantially free of isocyanate groups. For example, in some embodiments, the reaction product does not have an isocyanate absorbance peak at about 2270 cm⁻¹ as measured by infrared spectroscopy.

In other embodiments, the reaction product may be substantially free of unreacted hydroxyl groups. For example, in some embodiments, the reaction product does not have a hydroxyl absorbance peak at about 3500 cm⁻¹ as measured by infrared spectroscopy.

In yet other embodiments, the reaction product may have an oxazolidone-isocyanurate peak in the range of 1710 to 1760 cm⁻¹, while not exhibiting an isocyanate absorbance peak at about 2270 cm⁻¹ and a hydroxyl absorbance peak at about 3500 cm⁻¹ as measured by infrared spectroscopy.

As described above, embodiments disclosed herein include various components, such as isocyanates, blocked isocyanates, epoxy resins, catalysts, hardeners, and substrates. Examples of each of these components are described in more detail below.

Isocyanate

Isocyanates useful in embodiments disclosed herein may include isocyanates, polyisocyanates, and isocyanate prepolymers. Suitable polyisocyanates include any of the known aliphatic, alicyclic, cycloaliphatic, araliphatic, and aromatic di- and/or polyisocyanates. Inclusive of these isocyanates are variants such as uretdiones, biurets, allophanates, isocyanurates, carbodiimides, and carbamates, among others.

Aliphatic polyisocyanates may include hexamethylene diisocyanate, trimethylhexamethylene diisocyanate, dimeric acid diisocyanate, lysine diisocyanate and the like, and biuret-type adducts and isocyanurate ring adducts of these polyisocyanates. Alicyclic diisocyanates may include isophorone diisocyanate, 4,4′-methylenebis(cyclohexylisocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate, and the like, and biuret-type adducts and isocyanurate ring adducts of these polyisocyanate. Aromatic diisocyanate compounds may include xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluydine diisocyanate, 4,4′-diphenyl ether diisocyanate, m- or p-phenylene diisocyanate, 4,4′-biphenylene diisocyanate, 3,3′-dimethyl-4,4′-biphenylene diisocyanate, bis(4-isocyanatophenyl)-sulfone, isopropylidenebis(4-phenylisocyanate), and the like, and biuret type adducts and isocyanurate ring adducts of these polyisocyanates. Polyisocyanates having three or more isocyanate groups per molecule may include, for example, triphenylmethane-4,4′,4″-triisocyanate, 1,3,5-triisocyanato-benzene, 2,4,6-triisocyanatotoluene, 4,4′-dimethyldiphenylmethane-2,2′,5,5′-tetraisocyanate, and the like, biuret type adducts and isocyanurate ring adducts of these polyisocyanates. Additionally, isocyanate compounds used herein may include urethanation adducts formed by reacting hydroxyl groups of polyols such as ethylene glycol, propylene glycol, 1,4-butylene glycol, dimethylolpropionic acid, polyalkylene glycol, trimethylolpropane, hexanetriol, and the like with the polyisocyanate compounds, and biuret type adducts and isocyanurate ring adducts of these polyisocyanates.

Other isocyanate compounds may include tetramethylene diisocyanate, toluene diisocyanate, hydrogenated diphenylmethane diisocyanate, hydrogenated xylylene diisocyanate, and trimers of these isocyanate compounds; terminal isocyanate group-containing compounds obtained by reacting the above isocyanate compound in an excess amount and a low molecular weight active hydrogen compounds (e.g., ethylene glycol, propylene glycol, trimethylolpropane, glycerol, sorbitol, ethylenediamine, monoethanolamine, diethanolamine, triethanolamine etc.) or high molecular weight active hydrogen compounds such as polyesterpolyols, polyetherpolyols, polyamides and the like may be used in embodiments disclosed herein.

Other useful polyisocyanates include, but are not limited to 1,2-ethylenediisocyanate, 2,2,4- and 2,4,4-trimethyl-1,6-hexamethylenediisocyanate, 1,12-dodecandiisocyanate, omega, omega-diisocyanatodipropylether, cyclobutan-1,3-diisocyanate, cyclohexan-1,3- and 1,4-diisocyanate, 2,4- and 2,6-diisocyanato-1-methylcylcohexane, 3-isocyanatomethyl-3,5,5-trimethylcyclohexylisocyanate (“isophoronediisocyanate”), 2,5- and 3,5-bis-(isocyanatomethyl)-8-methyl-1,4-methano, decahydronaphthathalin, 1,5-, 2,5-, 1,6- and 2,6-bis-(isocyanatomethyl)-4,7-methanohexahydroindan, 1,5-, 2,5-, 1,6- and 2,6-bis-(isocyanato)-4,7-methanohexahydroindan, dicyclohexyl-2,4′- and -4,4′-diisocyanate, omega, omega-diisocyanato-1,4-diethylbenzene, 1,3- and 1,4-phenylenediisocyanate, 4,4′-diisocyanatodiphenyl, 4,4′-diisocyanato-3,3′-dichlorodiphenyl, 4,4′-diisocyanato-3,3′methoxy-diphenyl, 4,4′-diisocyanato-3,3′-diphenyl-diphenyl, naphthalene-1,5-diisocyanate, N—N′-(4,4′-dimethyl-3,3′-diisocyanatodiphenyl)-uretdion, 2,4,4′-triisocyanatano-diphenylether, 4,4′,4″-triisocyanatotriphenylmethant, and tris(4-isocyanatophenyl)-thiophosphate.

Other suitable polyisocyanates may include: 1,8-octamethylenediisocyanate; 1,11-undecane-methylenediisocyanate; 1,12-dodecamethylendiisocyanate; 1-isocyanato-3-isocyanatomethyl-3,5,5-trimethylcyclohexane; 1-isocyanato-1-methyl-4(3)-isocyanatomethylcyclohexane; 1-isocyanato-2-isocyanatomethylcyclopentane; (4,4′- and/or 2,4′-) diisocyanato-dicyclohexylmethane; bis-(4-isocyanato-3-methylcyclohexyl)-methane; a,a,a′,a′-tetramethyl-1,3- and/or -1,4-xylylenediisocyanate; 1,3- and/or 1,4-hexahydroxylylene-diisocyanate; 2,4- and/or 2,6-hexahydrotoluene-diisocyanate; 2,4- and/or 2,6-toluene-diisocyanate; 4,4′- and/or 2,4′-diphenylmethane-diisocyanate; n-isopropenyl-dimethylbenzyl-isocyanate; any double bond containing isocyanate; and any of their derivatives having urethane-, isocyanurate-, allophanate-, biuret-, uretdione-, and/or iminooxadiazindione groups.

The polyisocyanate may also contain urethane groups. Such modified polyisocyanates may be obtained by reacting polyol with the polyisocyanate. Examples of suitable polyols include: ethylene glycol; 1,2- and 1,3-propanediol; 1,2-butanediol; 1,3-butanediol; 1,4-butanediol; 2,3-butanediol; neopentylglycol; 1,6-hexanediol; 2-methyl-1,3-propanediol-; 2,2,4-tri methyl-1,3-pentanediol; 2-n-butyl-2-ethyl-1,3-propanediol; glycerine monoalkanoates (e.g., glycerine monostearates); dimer fatty alcohols; diethylene glycol; triethylene glycol; tetraethylene glycol; 1,4-dimethylolcyclohexane; dodecanediol; bisphenol-A; hydrogenated bisphenol A; 1,3-hexanediol; 1,3-octanediol; 1,3-decanediol; 3-methyl-1,5-pentanediol; 3,3-dimethyl-1,2-butanediol; 2-methyl-1,3-pentanediol; 2-methyl-2,4-pentanediol; 3-hydroxymethyl-4-heptanol; 2-hydroxymethyl-2,3-dimethyl-1-pentanol; glycerine; trimethylol ethane; trimethylol propane; trimerized fatty alcohols; isomeric hexanetriols; sorbitol; pentaerythritol; di- and/or tri-methylolpropane; di-pentaerythritol; diglycerine; 2,3-butenediol; trimethylol propane monoallylether; fumaric and/or maleinic acid containing polyesters; 4,8-bis-(hydroxymethyl)-tricyclo[5,2,0(2,6)]-decane long chain alcohols. Suitable hydroxy-functional esters may be prepared by the addition of the above-mentioned polyols with epsilon-caprolactone or reacted in a condensation reaction with an aromatic or aliphatic diacid. These polyols may be reacted with any of the isocyanates described above.

Polyisocyanates may also include aliphatic compounds such as trimethylene, pentamethylene, 1,2-propylene, 1,2-butylene, 2,3-butylene, 1,3-butylene, ethylidene and butylidene diisocyanates, and substituted aromatic compounds such as dianisidine diisocyanate, 4,4′-diphenylether diisocyanate and chlorodiphenylene diisocyanate. In addition, the isocyanate may be a prepolymer derived from a polyol including polyether polyol or polyester polyol, including polyethers which are reacted with excess polyisocyanates to form isocyanate-terminated pre-polymers. The polyols may be simple polyols such as glycols, e.g., ethylene glycol and propylene glycol, as well as other polyols such as glycerol; tri-methylolpropane, pentaerythritol, and the like, as well as mono-ethers such as diethylene glycol, tripropylene glycol and the like and poly-ethers, i.e., alkylene oxide condensates of the above. Among the alkylene oxides that may be condensed with these polyols to form polyethers are ethylene oxide, propylene oxide, butylene oxide, styrene oxide and the like. These are generally called hydroxyl-terminated polyethers and can be linear or branched. Examples of polyethers include polyoxyethylene glycol, polyoxypropylene glycol, polyoxytetramethylene glycol, polyoxyhexamethylene glycol, polyoxynonamethylene glycol, polyoxydecamethylene glycol, polyoxydodecamethylene glycol and mixtures thereof. Other types of polyoxyalkylene glycol ethers may be used. Especially useful polyether polyols are those derived from reacting polyols such as ethylene glycol, diethylene glycol, triethylene glycol, 1,4-butylene glycol, 1,3-butylene glycol, 1,6-hexanediol, and their mixtures; glycerol, trimethylolethane, trimethylolpropane, 1,2,6-hexanetriol, pentaerythritol, dipentaerythritol, tripentaerythritol, polypentaerythritol, sorbitol, methyl glucosides, sucrose and the like with alkylene oxides such as ethylene oxide, propylene oxide, their mixtures, and the like.

Additionally, useful polyisocyanates include those obtained by reacting the above mentioned di- and triisocyanates with multifunctional alcohols containing 2-12 carbon atoms and 2-6 hydroxy groups. Other suitable polyisocyanates may include those obtained by oligomerization and containing any of the following groups: isocyanurate, uretdione, allophanate, biuret, uretonimin, urea, urethane, and carbodiimide containing derivatives, including prepolymers, of the foregoing polyisocyanates are also suitable.

Isocyanate prepolymers may be formed by condensation polymerization of a stoichiometric excess of polyisocyanate with a polyol. Suitable polyols include those described in U.S. Pat. No. 4,456,642, the disclosure of which is incorporated by reference. Suitable polyols are represented by polyether polyols, polyester polyols, polycarbonate polyols and polyacetal polyols. Polyamino- or polymercapto-containing compounds may also be included. Suitable polyether polyols include those prepared by polymerizing an alkylene oxide in the presence of a two to eight functional initiator compound. Examples of appropriate initiators include water, alcohols, diols, ammonia, amines, and polyfunctional hydroxylated initiators such as glycerine, sorbitol, and sucrose. Examples of such polyether polyols include polyethyleneoxy polyols, polypropyleneoxy polyols, polybutyleneoxy polyols, and block copolymers of ethylene oxide and propylene oxide. Suitable exemplary polyols include VORANOL P 400, VORANOL P 2000, VORANOL EP 1900, VORANOL CP 4755, and VORANOL HF 505, each available from The Dow Chemical Company. Suitable polyether polyols may also include polytetramethylene glycols. Suitable polyester polyols may include polyesters formed from a glycol and a saturated polyfunctional dicarboxylic acid such as prepared by reacting monoethylene glycol with adipic acid. Suitable polyester polyols with improved hydrolytic stability include polyesters formed from a glycol and a saturated polyfunctional dicarboxylic acid such as prepared by reacting hexanediol with dodecanoic acid. Also polyester of lactones may be employed for the purposes of the present invention. Polyhydroxy compounds corresponding to naturally occurring polyols (for instance, castor oil), eventually in derivatized form, may also be suitable for the purposes of the present invention. Also, polyhydroxy compounds modified by vinyl polymers, which may be obtained by the polymerization of styrene and acrylonitrile in the presence of polyether polyols, may be suitable for the embodiments disclosed herein. Polyhydroxy compounds, in which high molecular weight polyadducts or polycondensates are contained in a finely dispersed or dissolved form, may also be employed in the present invention.

Other isocyanate compounds are described in, for example, U.S. Pat. Nos. 6,288,176, 5,559,064, 4,637,956, 4,870,141, 4,767,829, 5,108,458, 4,976,833, and 7,157,527, U.S. Patent Application Publication Nos. 20050187314, 20070023288, 20070009750, 20060281854, 20060148391, 20060122357, 20040236021, 20020028932, 20030194635, and 20030004282, each of which is hereby incorporated by reference. Isocyanates formed from polycarbamates are described in, for example, U.S. Pat. No. 5,453,536, hereby incorporated by reference herein. Carbonate isocyanates are described in, for example, U.S. Pat. No. 4,746,754, hereby incorporated by reference herein.

Mixtures of any of the above-listed isocyanates may, of course, also be used.

Isocyanate Blocking Agent

Isocyanate blocking agents may include alcohols, ethers, phenols, malonate esters, methylenes, acetoacetate esters, lactams, oximes, and ureas, among others. Other blocking agents for isocyanate groups include compounds such as bisulphites, and phenols, alcohols, lactams, oximes and active methylene compounds, each containing a sulfone group. Also, mercaptans, triazoles, pyrrazoles, secondary amines, and also malonic esters and acetylacetic acid esters may be used as a blocking agent. The blocking agent may include glycolic acid esters, acid amides, aromatic amines, imides, active methylene compounds, ureas, diaryl compounds, imidazoles, carbamic acid esters, or sulfites.

For example, phenolic blocking agent may include phenol, cresol, xylenol, chlorophenol, ethylphenol and the like. Lactam blocking agent may include gamma-pyrrolidone, laurinlactam, epsilon-caprolactam, delta-valerolactam, gamma-butyrolactam, beta-propiolactam and the like. Methylene blocking agent may include acetoacetic ester, ethyl acetoacetate, acetyl acetone and the like. Oxime blocking agents may include formamidoxime, acetaldoxime, acetoxime, methylethylketoxine, diacetylmonoxime, cyclohexanoxime and the like; mercaptan blocking agent such as butyl mercaptan, hexyl mercaptan, t-butyl mercaptan, thiophenol, methylthiophenol, ethylthiophenol and the like. Acid amide blocking agents may include acetic acid amide, benzamide and the like. Imide blocking agents may include succinimide, maleimide and the like. Amine blocking agents may include xylidine, aniline, butylamine, dibutylamine diisopropyl amine and benzyl-tert-butyl amine and the like. Imidazole blocking agents may include imidazole, 2-ethylimidazole and the like. Imine blocking agents may include ethyleneimine, propyleneimine and the like. Triazoles blocking agents may include compounds such as 1,2,4-triazole, 1,2,3-benzotriazole, 1,2,3-tolyl triazole and 4,5-diphenyl-1,2,3-triazole.

Alcohol blocking agents may include methanol, ethanol, propanol, butanol, amyl alcohol, ethylene glycol monomethyl ether, ethylene glycol monoethyl ether, ethylene glycol monobutyl ether, diethylene glycol monomethyl ether, propylene glycol monomethyl ether, benzyl alcohol, methyl glycolate, butyl glycolate, diacetone alcohol, methyl lactate, ethyl lactate and the like. Additionally, any suitable aliphatic, cycloaliphatic or aromatic alkyl monoalcohol may be used as a blocking agent in accordance with the present disclosure. For example, aliphatic alcohols, such as methyl, ethyl, chloroethyl, propyl, butyl, amyl, hexyl, heptyl, octyl, nonyl, 3,3,5-trimethylhexyl, decyl, and lauryl alcohols, and the like may be used. Suitable cycloaliphatic alcohols include, for example, cyclopentanol, cyclohexanol and the like, while aromatic-alkyl alcohols include phenylcarbinol, methylphenylcarbinol, and the like.

Examples of suitable dicarbonylmethane blocking agents include: malonic acid esters such as diethyl malonate, dimethyl malonate, di(iso)propyl malonate, di(iso)butyl malonate, di(iso)pentyl malonate, di(iso)hexyl malonate, di(iso)heptyl malonate, di(iso)octyl malonate, di(iso)nonyl malonate, di(iso)decyl malonate, alkoxyalkyl malonates, benzylmethyl malonate, di-tert-butyl malonate, ethyl-tert-butyl malonate, dibenzyl malonate; and acetylacetates such as methyl acetoacetate, ethyl acetoacetate, propyl acetoacetate, butyl acetoacetate and alkoxyalkylacetoacetates; cyanacetates such as cyanacetic acid ethylester; acetylacetone; 2,2-dimethyl-1,3-dioxane-4,6-dione; methyl trimethylsilyl malonate, ethyl trimethylsilyl malonate, and bis(trimethylsilyl)malonate.

Malonic or alkylmalonic acid esters derived from linear aliphatic, cycloaliphatic, and/or arylalkyl aliphatic alcohols may also be used. Such esters may be made by alcoholysis using any of the above-mentioned alcohols or any monoalcohol with any of the commercially available esters (e.g., diethylmalonate). For example, diethyl malonate may be reacted with 2-ethylhexanol to obtain the bis-(2-ethylhexyl)-malonate. It is also possible to use mixtures of alcohols to obtain the corresponding mixed malonic or alkylmalonic acid esters. Suitable alkylmalonic acid esters include: butyl malonic acid diethylester, diethyl ethyl malonate, diethyl butyl malonate, diethyl isopropyl malonate, diethyl phenyl malonate, diethyl n-propyl malonate, diethyl isopropyl malonate, dimethyl allyl malonate, diethyl chloromalonate, and dimethyl chloro-malonate.

Other isocyanate blocking agents are described in, for example, U.S. Pat. Nos. 6,288,176, 5,559,064, 4,637,956, 4,870,141, 4,767,829, 5,108,458, 4,976,833, and 7,157,527, U.S. Patent Application Publication Nos. 20050187314, 20070023288, 20070009750, 20060281854, 20060148391, 20060122357, 20040236021, 20020028932, 20030194635, and 20030004282, each of which is incorporated herein by reference.

Mixtures of the above-listed isocyanate blocking agents may also be used.

Forming a Blocked Isocyanate

In some embodiments, blocked polyisocyanate compounds may include, for example, polyisocyanates having at least two free isocyanate groups per molecule, where the isocyanate groups are blocked with an above-described isocyanate blocking agent. The blocked isocyanate may be prepared by reaction of the above-mentioned isocyanate compound and a blocking agent by a conventionally known appropriate method.

In other embodiments, the capped or blocked isocyanates used in embodiments disclosed herein may be any isocyanate where the isocyanate groups have been reacted with an isocyanate blocking compound so that the resultant capped isocyanate is stable to active hydrogens at room temperature but reactive with active hydrogens at elevated temperatures, such as between about 90° C. to 200° C. U.S. Pat. No. 4,148,772, for example, describes the reaction between polyisocyanates and capping agent, fully or partially capped isocyanates, and the reaction with or without the use of a catalyst, and is incorporated herein by reference.

Formed blocked polyisocyanate compounds are typically stable at room temperature. When heated, for example, to 100° C. or above in some embodiments, or to 120° C., 130° C., 140° C. or above in other embodiments, the blocking agent is dissociated to regenerate the free isocyanate groups, which may readily react with hydroxyl groups.

In other embodiments, the polymer may be made using reactive extrusion process disclosed in WO1994015985. That publication is incorporated by reference in its entirety.

Epoxy Resins

The epoxy resins used in embodiments disclosed herein may vary and include conventional and commercially available epoxy resins, which may be used alone or in combinations of two or more, including, for example, novalac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition.

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene)phenol diglycidyl ether and (chloromethyl)oxirane bisphenol A diglycidyl ether.

In some embodiments, the epoxy resin may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobispehnol A (2,2-bis(4-(2,3-epoxypropoxy)-3-bromo-phenyl)propane), diglydicylether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found may be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy napthalene; modified epoxy resins with acrylate or urethane moieties; glycidlyamine epoxy resins; and novolac resins.

The epoxy compounds may be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are particularly useful include those based on glycidyl ether monomers. Examples are di- or polyglycidyl ethers of polyhydric phenols obtained by reacting a polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R. 331 (bisphenol A liquid epoxy resin) and D.E.R. 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl)adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the tradename D.E.R. 580, available from The Dow Chemical Company, Midland, Mich.); 1,4-butanediol diglycidyl ether of phenolformaldehyde novolac (such as those available under the tradenames D.E.N. 431 and D.E.N. 438 available from The Dow Chemical Company, Midland, Mich.); and resorcinol diglycidyl ether Although not specifically mentioned, other epoxy resins under the tradename designations D.E.R. and D.E.N. available from the Dow Chemical Company may also be used.

Epoxy resins may also include isocyanate modified epoxy resins. Polyepoxide polymers or copolymers with isocyanate or polyisocyanate functionality may include epoxy-polyurethane copolymers. These materials may be formed by the use of a polyepoxide prepolymer having one or more oxirane rings to give a 1,2-epoxy functionality and also having open oxirane rings, which are useful as the hydroxyl groups for the dihydroxyl-containing compounds for reaction with diisocyanate or polyisocyanates. The isocyanate moiety opens the oxirane ring and the reaction continues as an isocyanate reaction with a primary or secondary hydroxyl group. There is sufficient epoxide functionality on the polyepoxide resin to enable the production of an epoxy polyurethane copolymer still having effective oxirane rings. Linear polymers may be produced through reactions of diepoxides and diisocyanates. The di- or polyisocyanates may be aromatic or aliphatic in some embodiments.

Other suitable epoxy resins are disclosed in, for example, U.S. Pat. Nos. 7,163,973, 6,632,893, 6,242,083, 7,037,958, 6,572,971, 6,153,719, and 5,405,688 and U.S. Patent Application Publication Nos. 20060293172 and 20050171237, each of which is hereby incorporated herein by reference.

As described below, curing agents may include epoxy functional groups. These epoxy-containing curing agents should not be considered herein part of the above described epoxy resins.

Catalysts

Catalysts may include imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methylimidazolium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxymethylimidazole; and condensing them by deformaldehyde reaction, e.g., 4,4′-methylene-bis-(2-ethyl-5-methylimidazole), and the like.

In other embodiments, suitable catalysts may include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

Non-amine catalysts may also be used. Organometallic compounds of bismuth, lead, tin, titanium, iron, antimony, uranium, cadmium, cobalt, thorium, aluminum, mercury, zinc, nickel, cerium, molybdenum, vanadium, copper, manganese, and zirconium, may be used. Illustrative examples include bismuth nitrate, lead 2-ethylhexoate, lead benzoate, ferric chloride, antimony trichloride, stannous acetate, stannous octoate, and stannous 2-ethylhexoate.

Other catalysts disclosed in PCT Publication No. WO 00/15690, for example may be used, which is incorporated by reference in its entirety.

Epoxy Hardeners/Curing Agents

A hardener or curing agent may be provided for promoting crosslinking of the epoxy resin composition to form a polymer composition. As with the epoxy resins, the hardeners and curing agents may be used individually or as a mixture of two or more.

Curing agents may include primary and secondary polyamines and adducts thereof, anhydrides, and polyamides. For example, polyfunctional amines may include aliphatic amine compounds such as diethylene triamine (D.E.H. 20, available from The Dow Chemical Company, Midland, Mich.), triethylene tetramine (D.E.H. 24, available from The Dow Chemical Company, Midland, Mich.), tetraethylene pentamine (D.E.H. 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener or curing agent may include a phenol-derived or substituted phenol-derived novolac or an anhydride. Non-limiting examples of suitable hardeners include phenol novolac hardener, cresol novolac hardener, dicyclopentadiene phenol hardener, limonene type hardener, anhydrides, and mixtures thereof.

In some embodiments, the phenol novolac hardener may contain a biphenyl or naphthyl moiety. The phenolic hydroxy groups may be attached to the biphenyl or naphthyl moiety of the compound. This type of hardener may be prepared, for example, according to the methods described in EP915118A1. For example, a hardener containing a biphenyl moiety may be prepared by reacting phenol with bismethoxy-methylene biphenyl.

In other embodiments, curing agents may include dicyandiamide, boron trifluoride monoethylamine, and diaminocyclohexane. Curing agents may also include imidazoles, their salts, and adducts. These epoxy curing agents are typically solid at room temperature. Examples of suitable imadazole curing agents are disclosed in EP906927A1. Other curing agents include aromatic amines, aliphatic amines, anhydrides, and phenols.

In some embodiments, the curing agents may be an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of curing agents useful in embodiments disclosed herein include: 3,3′- and 4,4′-diaminodiphenylsulfone; methylenedianiline; bis(4-amino-3,5-dimethylphenyl)-1,4-diisopropylbenzene available as EPON 1062 from Shell Chemical Co.; and bis(4-aminophenyl)-1,4-diisopropylbenzene available as EPON 1061 from Shell Chemical Co.

Thiol curing agents for epoxy compounds may also be used, and are described, for example, in U.S. Pat. No. 5,374,668. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercaptosuccinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl)isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl)disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The curing agent may also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or methacrylates may also be utilized as curing agents. In addition, various Mannich bases can be used. Aromatic amines wherein the amine groups are directly attached to the aromatic ring may also be used.

Quaternary ammonium salts with a nucleophilic anion useful as a curing agent in embodiments disclosed herein may include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium cyanate, N-methylpyrridinium phenolate, N-methyl-o-chloropyrridinium chloride, methyl viologen dichloride and the like.

The suitability of the curing agent for use herein may be determined by reference to manufacturer specifications or routine experimentation. Manufacturer specifications may be used to determine if the curing agent is an amorphous solid or a crystalline solid at the desired temperatures for mixing with the liquid or solid epoxy. Alternatively, the solid curing agent may be tested using simple crystallography to determine the amorphous or crystalline nature of the solid curing agent and the suitability of the curing agent for mixing with the epoxy resin in either liquid or solid form.

Optional Additives

The composition may also include optional additives and fillers conventionally found in epoxy systems. Additives and fillers may include silica, glass, talc, metal powders, titanium dioxide, wetting agents, pigments, coloring agents, mold release agents, coupling agents, flame retardants, ion scavengers, UV stabilizers, flexibilizing agents, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers and modifiers may be preheated to drive off moisture prior to addition to the epoxy resin composition. Additionally, these optional additives may have an effect on the properties of the composition, before and/or after curing, and should be taken into account when formulating the composition and the desired reaction product.

In some embodiments, minor amounts of even higher molecular weight relatively non-volatile monoalcohols, polyols, and other epoxy- or isocyanato-reactive diluents may be used, if desired, to serve as plasticizers in the coatings disclosed herein.

Curable Compositions

The proportions of blocked polyisocyanate and epoxy resin may depend, in part, upon the properties desired in the curable composition or coating to be produced, the desired cure response of the composition, and the desired storage stability of the composition (desired shelf life). The curable compositions and the composites described herein may be produced conventionally, accounting for the alteration in the isocyanate and epoxy resin compositions before they are cured.

For example, in some embodiments, a curable composition may be formed by admixing a blocked isocyanate, an epoxy resin, and a catalyst to form a mixture. The relative amounts of blocked isocyanate, epoxy resin, and catalyst may depend upon the desired properties of the cured composition, as described above. In other embodiments, a process to form a curable composition may include one or more of the steps of forming an isocyanate prepolymer, forming a blocked isocyanate, admixing a curing agent, and admixing additives.

In some embodiments, the epoxy resin may be present in an amount range from 0.1 to 99 weight percent of the curable composition. In other embodiments, the epoxy resin may range from 0.1 to 50 weight percent of the curable composition; from 15 to 45 weight percent in other embodiments; and from 25 to 40 weight percent in yet other embodiments. In other embodiments, the epoxy resin may range from 50 to 99 weight percent of the curable composition; from 60 to 95 weight percent in yet other embodiments; and from 70 to 90 weight percent in yet other embodiments.

In some embodiments, the blocked isocyanate may be present in an amount range from 0.1 to 99 weight percent of the curable composition. In other embodiments, the blocked isocyanate may range from 0.1 to 50 weight percent of the curable composition; from 15 to 45 weight percent in other embodiments; and from 25 to 40 weight percent in yet other embodiments. In other embodiments, the blocked isocyanate may range from 50 to 99 weight percent of the curable composition; from 60 to 95 weight percent in yet other embodiments; and from 70 to 90 weight percent in yet other embodiments.

In some embodiments, the catalyst may be present in an amount ranging from 0.01 weight percent to 10 weight percent. In other embodiments, the catalyst may be present in an amount ranging from 0.1 weight percent to 8 weight percent; from 0.5 weight percent to 6 weight percent in other embodiments; and from 1 to 4 weight percent in yet other embodiments.

In some embodiments, hardeners may also be admixed with the epoxy resin, the blocked isocyanate, and the catalyst. Variables to consider in selecting a curing agent and an amount of curing agent may include, for example, the epoxy resin composition (if a blend), the desired properties of the cured composition (flexibility, electrical properties, etc.), desired cure rates, as well as the number of reactive groups per catalyst molecule, such as the number of active hydrogens in an amine. The amount of curing agent used may vary from 0.1 to 150 parts per hundred parts epoxy resin, by weight, in some embodiments. In other embodiments, the curing agent may be used in an amount ranging from 5 to 95 parts per hundred parts epoxy resin, by weight; and the curing agent may be used in an amount ranging from 10 to 90 parts per hundred parts epoxy resin, by weight, in yet other embodiments.

The curable compositions described above may be disposed on a substrate and cured, as will be described below. In some embodiments, the curable compositions may be cured or reacted to form at least one of an oxazolidone and an isocyanurate ring, wherein the reaction product has an oxazolidone-isocyanurate peak in the range of 1710 to 1760 cm⁻¹ as measured by infrared spectroscopy.

In other embodiments, the reaction product may be substantially free of isocyanate groups. For example, in some embodiments, the reaction product does not have an isocyanate absorbance peak at about 2270 cm⁻¹ as measured by infrared spectroscopy.

In other embodiments, the reaction product may be substantially free of unreacted hydroxyl groups. For example, in some embodiments, the reaction product does not have a hydroxyl absorbance peak at about 3500 cm⁻¹ as measured by infrared spectroscopy. Unreacted hydroxyl groups may result, for example, where there is incomplete reaction of a phenol or alcohol blocking agent with the epoxy resin, or where there is a volatile or stable reaction by-product, such as isopropanol.

In yet other embodiments, the reaction product may have an oxazolidone-isocyanurate peak in the range of 1710 to 1760 cm⁻¹, while not exhibiting an isocyanate absorbance peak at about 2270 cm⁻¹ and a hydroxyl absorbance peak at about 3500 cm⁻¹ as measured by infrared spectroscopy.

Substrates

The substrate or object is not subject to particular limitation. As such, substrates may include metals, such as stainless steel, iron, steel, copper, zinc, tin, aluminium, alumite and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS® or C glass; and silicon carbide or silicon carbide fibers containing titanium. Commercially available fibers may include: organic fibers, such as KEVLAR; aluminum oxide-containing fibers, such as NEXTEL fibers from 3M; silicon carbide fibers, such as NICALON from Nippon Carbon; and silicon carbide fibers containing titanium, such as TYRRANO from Ube. In some embodiments, the substrate may be coated with a compatibilizer to improve the adhesion of the curable or cured composition to the substrate.

In selected embodiments, the curable compositions described herein may be used as coatings for substrates that cannot tolerate high temperatures. In other embodiments, the curable compositions may be used with substrates whose dimensions and shape make it difficult to apply homogeneous heating, such as windmill blades, for example.

Composites and Coated Structures

In some embodiments, composites may be formed by curing the curable compositions disclosed herein. In other embodiments, composites may be formed by applying a curable epoxy resin composition to a substrate or a reinforcing material, such as by impregnating or coating the substrate or reinforcing material, and curing the curable composition.

The above described curable compositions may be in the form of a powder, slurry, or a liquid. After a curable composition has been produced, as described above, it may be disposed on, in, or between the above described substrates, before, during, or after cure of the curable composition.

For example, a composite may be formed by coating a substrate with a curable composition. Coating may be performed by various procedures, including spray coating, curtain flow coating, coating with a roll coater or a gravure coater, brush coating, and dipping or immersion coating.

In various embodiments, the substrate may be monolayer or multi-layer. For example, the substrate may be a composite of two alloys, a multi-layered polymeric article, and a metal-coated polymer, among others, for example. In other various embodiments, one or more layers of the curable composition may be disposed on a substrate. For example, a substrate coated with a polyurethane-rich curable composition as described herein may additionally be coated with an epoxy resin-rich curable composition. Other multi-layer composites, formed by various combinations of substrate layers and curable composition layers are also envisaged herein.

In some embodiments, the heating of the curable composition may be localized, such as to avoid overheating of a temperature-sensitive substrate, for example. In other embodiments, the heating may include heating the substrate and the curable composition.

In one embodiment, the curable compositions, composites, and coated structures described above may be cured by heating the curable composition to a temperature sufficient to form oxazolidone. The formation of oxazolidone, even at relatively low to moderate temperatures, may boost the temperature of the curable composition by internal heating as a result of the high enthalpy of the oxazolidone-forming reactions.

The curing may be completed by heating, either externally or internally, the curable composition to a temperature sufficient to de-block the blocked isocyanate. For example, an isocyanate blocked with a compound containing phenolic OH groups may be de-blocked at about 120° C., allowing both the phenolic compound and the isocyanate to react with the epoxy resin, forming polyether and a polyoxazolidone, respectively. Polyisocyanurate and polyurethane may also be formed during the reaction. The increase in temperature to de-block the isocyanate may be achieved, as described above, by external heating or internal exotherms.

Curing of the curable compositions disclosed herein may require a temperature of at least about 30° C., up to about 250° C., for periods of minutes up to hours, depending on the epoxy resin, curing agent, and catalyst, if used. In other embodiments, curing may occur at a temperature of at least 100° C., for periods of minutes up to hours. Post-treatments may be used as well, such post-treatments ordinarily being at temperatures between about 100° C. and 200° C.

In some embodiments, curing may be staged to prevent exotherms. Staging, for example, includes curing for a period of time at a temperature followed by curing for a period of time at a higher temperature. Staged curing may include two or more curing stages, and may commence at temperatures below about 180° C. in some embodiments, and below about 150° C. in other embodiments.

In some embodiments, curing temperatures may range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

In some embodiments, de-blocking temperatures may range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

The curable compositions disclosed herein may be useful in composites containing high strength filaments or fibers such as carbon (graphite), glass, boron, and the like. Composites may contain from about 30% to about 70%, in some embodiments, and from 40% to 70% in other embodiments, of these fibers based on the total volume of the composite.

Fiber reinforced composites, for example, may be formed by hot melt prepregging. The prepregging method is characterized by impregnating bands or fabrics of continuous fiber with a thermosetting epoxy resin composition as described herein in molten form to yield a prepreg, which is laid up and cured to provide a composite of fiber and thermoset resin.

Other processing techniques can be used to form composites containing the epoxy-based compositions disclosed herein. For example, filament winding, solvent prepregging, and pultrusion are typical processing techniques in which the uncured epoxy resin may be used. Moreover, fibers in the form of bundles may be coated with the uncured epoxy resin composition, laid up as by filament winding, and cured to form a composite.

The curable compositions and composites described herein may be useful as adhesives, structural and electrical laminates, coatings, castings, structures for the aerospace industry, as circuit boards and the like for the electronics industry, windmill blades, as well as for the formation of skis, ski poles, fishing rods, and other outdoor sports equipment. The epoxy compositions disclosed herein may also be used in electrical varnishes, encapsulants, semiconductors, general molding powders, filament wound pipe, storage tanks, liners for pumps, and corrosion resistant coatings, among others.

### EXAMPLES

### Prepolymer Preparation

378.5 grams of a 1000 equivalent weight polypropylene glycol (VORANOL 220-056N, available from The Dow Chemical Company, Midland, Mich.) is placed in a jar, padded with nitrogen, and sealed. The jar is then heated to 60° C. and 0.5 grams of benzoyl chloride was added. 121.5 grams of pure MDI (ISONATE 125M) is then added to the jar, and the resulting mixture is heated at 80° C. for four hours. The resulting prepolymer has 5.07 mole percent free NCO. An infrared analysis of the resulting mixture shows an isocyanate absorbance peak at 2270 cm⁻¹.

Blocked Prepolymer Preparation

An aliquot of 76.7. grams of the prepolymer is blended with 23 grams of melted phenolic hardener (D.E.H. 85, having an equivalent molecular weight of 265, available from The Dow Chemical Company, Midland, Mich.). The resulting blend is heated at 95° C. for one hour. A DSC analysis of the resulting viscoelastic polymer shows a glass transition temperature of about 62.1° C., and no reaction enthalpy is detected. An infrared analysis of the resulting viscoelastic polymer shows a small isocyanate and hydroxyl absorbance peaks at 2270 cm⁻¹ and 3500 cm⁻¹, respectively, and a small isocyanurate peak at 1710 cm⁻¹. The presence of the isocyanate peak at 1710 cm⁻¹ indicates less NCO available to react with epoxy. The resulting viscoelastic polymer has an average equivalent weight of about 552 after de-blocking at around 120° C. Prepolymer average equivalent weight after de-blocking is calculated as follows: MW_{equiv}=500/(120/265+381/840).

Coating Powder Preparation

The above described blocked prepolymer is placed into a dry ice container for one hour and is then dry blended in a high speed grinder with a four-type solid epoxy resin (D.E.R. 664UE, available from The Dow Chemical Company, Midland, Mich.) and catalyst as follows:

| | |
|---|---|
| Blocked prepolymer | 4.2 parts |
| DER 664UE | 5.7 parts |
| 2-phyenyl imidazole | 0.015 parts |
| Boric acid: 2-metheyl imidazole | 0.2 parts |

The stoichiometric ratio of blocked prepolymer to solid epoxy resin used is 1.20. As the phenolic hardener also contains secondary OH groups that react with isocyanate to form a more stable urethane bond, an excess of 20 weight percent prepolymer is used to react with the four-type solid epoxy resin.

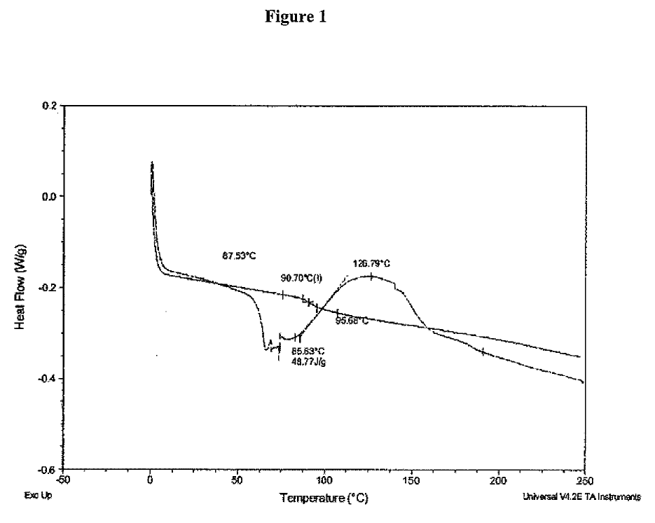

A DSC analysis of the resulting powder indicated the powder had a gel time of 26 seconds, a glass transition temperature of 90.7° C., a peak exotherm of 127° C., and an enthalpy of 48.8 J/g, as illustrated in FIG. 1. An infrared analysis of the resulting material shows no isocyanate or hydroxyl absorbance peak at 2270 cm⁻¹ and 3500 cm⁻¹, respectively, but shows an oxazolidone-isocyanurate peak in the range of 1710 to 1760 cm⁻¹. A small epoxy peak is detected at 910 cm⁻¹.

The resulting powder, as described above, may be used in powder coating applications. Similar compounds may also be used to form liquid coatings. The resulting system may cure at low temperatures, such as less than 150° C., with no sintering issues. The resulting polymer may have excellent adhesion to metal and heat sensitive substrates such as MDF and plastics. Additionally, depending upon the blocked isocyanate and epoxy resin used, the flexibility and thermal stability of the coating may be tuned. In some embodiments, the compositions may be used in a powder coating composition such as described in PCT Publication No. WO2006029141, which is incorporated by reference in its entirety.

As described above, curable compositions disclosed herein may include blocked isocyanates, epoxy resins, catalysts, and optionally hardeners or curing agents. Advantageously, embodiments disclosed herein may provide for compositions that allow curing to start at lower temperatures and to boost the temperature of the curable composition by internal heating as a consequence of the high enthalpy of oxazolidone-forming reactions. Additionally, further advantages may include one or more of enhanced heat resistance, tailored flow properties, and controlled cure profiles.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A process for forming a cured composition, comprising
admixing a blocked isocyanate, an epoxy resin, and a catalyst to form a mixture;
reacting the mixture to form at least one of oxazolidone and isocyanurate rings;
wherein the reaction product has an oxazolidone-isocyanurate peak in the range of 1710 to 1760 cm⁻¹ as measured by infrared spectroscopy.

2.-12. (canceled)

13. The process of claim 1, further comprising disposing the mixture on a substrate.

14. The process of claim 2, comprising disposing two or more layers of the mixture on the substrate.

15. An isocyanate-epoxy composition, comprising:
the reaction product of a blocked isocyanate and an epoxy resin;
wherein the reaction product has an oxazolidone-isocyanurate peak in the range of 1710 cm⁻¹ to 1760 cm⁻¹ as measured by infrared spectroscopy.

16. The composition of claim 15, wherein the reaction product does not have an isocyanate absorbance peak at about 2270 cm⁻¹ as measured by infrared spectroscopy.

17. The composition of claim 15, wherein the reaction product does not have a hydroxyl absorbance peak at about 3500 cm⁻¹ as measured by infrared spectroscopy.

18. A process for forming a coated substrate, comprising:
admixing a blocked isocyanate, an epoxy resin, and a catalyst to form a mixture;
coating a substrate with the mixture;
reacting the mixture to form at least one of oxazolidone and isocyanurate rings;
wherein the reaction product has an oxazolidone-isocyanurate peak in the range of 1710 to 1760 cm⁻¹ as measured by infrared spectroscopy.

19. The process of claim 1, wherein the reaction product does not have an isocyanate absorbance peak at about 2270 cm⁻¹ as measured by infrared spectroscopy.

20. The process of claim 1, wherein the reaction product does not have a hydroxyl absorbance peak at about 3500 cm⁻¹ as measured by infrared spectroscopy.

21. The process of claim 1, wherein the catalyst comprises at least one imidazole.

22. The process of claim 1, wherein the epoxy resin comprises at least one of a novalac resin, an epoxy compound, an isocyanate modified epoxy resin, and a carboxylate adduct.

23. The process of claim 1, wherein the admixing further comprises admixing an epoxy hardener to form the mixture; and wherein the epoxy hardener comprises at least one of water, an amines, a carboxylic acid, and a phenol.

24. (canceled)

25. The process of claim 1, further comprising forming a blocked isocyanate; and wherein the forming a blocked isocyanate comprises admixing an isocyanate compound with an isocyanate blocking agent.

26. (canceled)

27. The process of claim 1, wherein the isocyanate compound comprises at least one of uretdiones, biurets, allophanates, isocyanurates, carbodiimides, carbamates, and isocyanate prepolymers.

28. The process of claim 1, wherein the blocked isocyanate is an isocyanate aryl carbamate.

29. The process of claim 1, further comprising heating the mixture.
